(19) United States
(12) Patent Application Publication
(10) Pub. No.: US 2024/0113653 A1
(43) Pub. Date: Apr. 4, 2024

(54) Solar panel tripod stand with top ledge

(71) Applicant: Mario Ulysses Grassano, JR., Burbank, CA (US)

(72) Inventor: Mario Ulysses Grassano, JR., Burbank, CA (US)

(21) Appl. No.: 18/375,544

(22) Filed: Oct. 1, 2023

Related U.S. Application Data
(60) Provisional application No. 63/412,138, filed on Sep. 30, 2022.

(51) Int. Cl. H02S 20/30

(52) U.S. Cl. CPC H02S 20/30

(57) ABSTRACT

The invention is a solar panel tripod stand with a top ledge which provides the support and stability to stand a multi-panel briefcase-type or a large standard solar panel. The solar panel tripod consists of 6 main pieces—three tripod pieces (the two outside tripod legs which are equally & symmetrically angled at the meeting joint), two ledges, and one thin rope.

When the tripod stand with the top ledge is opened, a thin rope attached from the lower ledge to the middle leg prevents the stand from collapsing. The solar tripod stand folds up like a regular tripod stand after use.

### CROSS-REFERENCE TO RELATED APPLICATION

63/412,381

### BACKGROUND OF THE INVENTION

### Field of the Invention

The invention is a solar panel tripod stand for a multi-panel briefcase-type or large standard solar panel. Most solar panels sold in America, today, do not include stands. A simple, affordable, and portable solar panel tripod stand, like this, with a top ledge, makes it possible to properly stand a solar panel almost anywhere, because of the added top ledge.

### BRIEF SUMMARY OF THE INVENTION

The invention is a solar panel tripod stand with a necessary top ledge. It can be used on a multi-panel briefcase-type or a large standard solar panel. The necessary top ledge of the solar panel stand adds stability and support to the structure.

### BRIEF DESCRIPTION OF THE SEVERAL VIEWS OF THE DRAWING(S)

The structure of the invention is described, below, with reference to the accompanying drawing, in which the following:

FIG. 1 is a frontal view of the solar panel tripod stand for multi-panel briefcase-type or large standard solar panels.

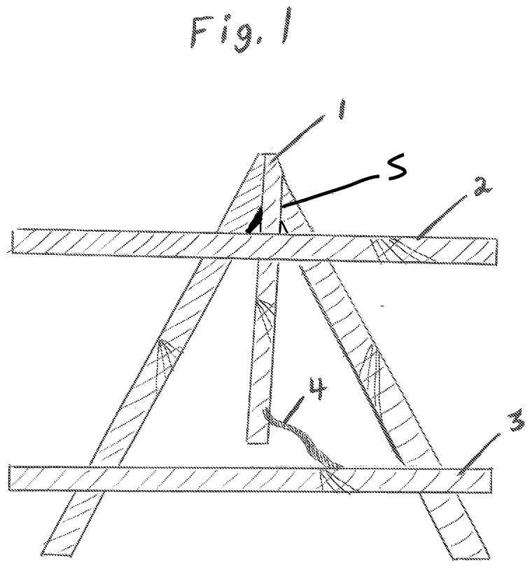

The invention's reference points on FIG. 1 are the three pieces that compromise the tripod stand at 1.; the top ledge at 2.; the bottom ledge at 3.; and the thin rope at 4. that prevents the tripod from collapsing that's attached from the bottom ledge to the middle tripod piece. Note: the two top outside tripod legs are equally & symmetrically angled at the meeting joint at 5.

### DETAILED DESCRIPTION OF THE INVENTION

This solar panel tripod stand is an improvement to the wooden artist easel, because it has a necessary top ledge. The top ledge is necessary to balance a foldable multi-panel briefcase-type solar panel or large standard solar panel. It adds the necessary stability and support to the structure to stand, even, a heavy large standard solar panel. Without the top ledge, the multi-panel briefcase type or large standard solar panel wouldn't be able to stand properly.

When the solar panel tripod stand, with the top ledge, is opened, a thin rope attached from the lower ledge to the middle tripod leg prevents the stand from collapsing. The stand folds up like a regular tripod easel after use.

The solar panel is compromised of 6 main pieces—three tripod legs (the two outside legs which angled at the meeting joint), two ledges, and one thin rope. It can be constructed of wood, plastic, aluminum, or steel.

Properly standing a multi-panel briefcase-type or large standard solar panel, with a top ledge, is a very important aspect of solar panel usage, especially, when camping. Being able to easily adjust the solar panel, as the sun moves across the sky, is also an aspect of this tripod stand. Also, portability is an important factor.

The purpose of the invention is, therefore, to provide a device that provides stability and support to stand solar panels, is portable, and is in a form which is economical to produce.

1. The invention is a portable solar panel tripod stand with a necessary top ledge that provides the support and stability required to stand a multi-panel briefcase-typel or a large standard solar panel.
